(19) United States
(12) Patent Application Publication
(10) Pub. No.: US 2009/0262053 A1
(43) Pub. Date: Oct. 22, 2009

(54) RESISTIVE MODULE, VOLTAGE DIVIDER AND RELATED LAYOUT METHODS

(76) Inventors: I-Ching Wei, Tao-Yuan City (TW); Kuan-Hung Liu, Taipei County (TW); Yi-Nan Chu, Changhua County (TW)

Correspondence Address: NORTH AMERICA INTELLECTUAL PROPERTY CORPORATION, P.O. BOX 506, MERRIFIELD, VA, 22116, US

(21) Appl. No.: 12/189,194

(22) Filed: Aug. 10, 2008

(30) Foreign Application Priority Data
Apr. 17, 2008 (TW) 097113953

(51) Int. Cl. G09G 3/36; H01C 7/22; G05F 1/656

(52) U.S. Cl. 345/87; 338/295; 323/233

(57) ABSTRACT

The present invention includes a resistive module, the resistive module including a plurality of nodes and at least a resistive component. The plurality of nodes include an input terminal and an output terminal of the resistive module; the resistive component is electronically connected between the input terminal and the output terminal of the resistive module to thereby make the input terminal and the output terminal have a specified resistive value therebetween. In addition, the resistive component is electrically connected between two nodes of a node pair among the nodes, and each resistive component has a corresponding predetermined resistive value.

### BACKGROUND OF THE INVENTION

1. Field of the Invention

The present invention relates to layout methods and devices thereof, and more particularly, to a resistive module, a voltage divider using the resistive module, and layout methods thereof.

2. Description of the Prior Art

Extensive experiments and data records have shown that a relationship between brain perception of human beings and luminance can be expressed by an equation: Y=AX^{Γ}; where a curve defined by such an equation is named a Gamma curve, and the magnitude of Γ (i.e., Gamma) differs from around 2.0 to 2.5 for various conditions. At present, display technologies need to execute calibrating operations for ensuring that data displayed by a display apparatus is in proportion to the brain perception precisely. Therefore, to achieve the goal of making the actual Gamma curve measured by a display apparatus more approximate to an ideal Gamma curve, it is required to devise a plurality of voltages (e.g., Gamma voltages) corresponding to different gray values, respectively, to generate precisely the wanted specified luminance.

Generally, for obtaining a plurality of driving voltage corresponding to different respective gray levels, conventional thin film transistor liquid crystal displays (TFT-LCD) generate a plurality of required Gamma reference voltages by cascading a plurality of resistive components in order to obtain the divided voltages matching the required Gamma voltages.

Please refer to FIG. 1; FIG. 1 is a diagram illustrating a conventional Gamma voltage divider 100. As shown in FIG. 1, the conventional Gamma voltage divider 100 includes a plurality of resistive components R₁-R₂ₙ₊₂, one reference voltage level Vdd1, another reference voltage level Vgn1 and a plurality of divided voltage output terminals V₁-Vₙ, wherein the resistive components R₁-R₂ₙ₊₂ have predetermined resistive values, respectively. The conventional Gamma voltage divider 100 adopts the resistive components R₁-R₂ₙ₊₂ for consequently forming a specified resistive value from every two serially-connected resistive components, for instance, R₁ and R₂, R₃ and R₄, etc. However, since the divided voltage generating manner employed in the conventional Gamma voltage divider 100 only has one fixed resistance arrangement (e.g., R₁+R₂, R₃+R₄, R₂ₙ₊₁+R₂ₙ₊₂); this leads to the derived resistive value (e.g., R₁+R₂) failing to match the ideal resistive value required by the ideal Gamma curve and consequently degrades the display quality of the LCD. For generating more precise resistive value required by each output terminal to improve the actual generated Gamma curve of the LCD, variable resistors are implemented for reducing the mismatch between actual resistive values and the required ideal resistive values.

Please refer to FIG. 2; FIG. 2 is a diagram illustrating another conventional Gamma voltage divider 200. As shown in FIG. 2, the conventional Gamma voltage divider 200 includes one reference voltage level Vdd2, one reference voltage level Vgn2, a plurality of variable resistors VR₁-VRₙ₊₁, and a plurality of divided voltage output terminals V₁-Vₙ. By using variable resistors VR₁-VRₙ₊₁ with tunable resistive values, the actual Gamma curve made from the more precise resistive values is closer to the ideal Gamma curve. The conventional Gamma voltage divider 200, however, also has some drawbacks such as higher cost due to implementation of variable resistors and increased layout area due to larger sizes of the variable resistors.

### SUMMARY OF THE INVENTION

It is therefore one of the objectives of the present invention to provide a resistive module, a voltage divider employing the resistive module and a circuit layout method thereof, to provide more precise resistive values required for improving an actual Gamma curve of a display apparatus, without significantly increasing the cost and layout area, in order to solve the aforementioned problems.

According to one aspect of the present invention, a circuit layout method adopting a resistive module is disclosed. The circuit layout method includes: defining a plurality of nodes on a circuit layout, wherein the nodes include an input terminal and an output terminal of the resistive module; for each node pair of a plurality of node pairs among the nodes, selecting a configuration manner for defining a circuit configuration of the node pair to make the input terminal and the output terminal of the resistive module have a correspondingly specified resistive value therebetween from three different configuration states, wherein the configuration states are an open-circuit configuration, a short-circuit configuration and a connecting configuration. The connecting configuration corresponds to the node pair and arranges a resistive component with a predetermined resistive value between nodes of the node pair.

According to another aspect of the present invention, a circuit layout method adopting a resistive module is disclosed. The circuit layout method includes: defining a plurality of nodes on a circuit layout in a matrix format, wherein the nodes include an input terminal and an output terminal of the resistive module; electronically connecting at least one resistive component between the input terminal and the output terminal to therefore make the input terminal and the output terminal of the resistive module have a specified resistive value therebetween, wherein the resistive component is connected between two nodes of one node pair among the nodes, and each of the resistive component has a correspondingly predetermined resistive value.

According to yet another aspect of the present invention, a circuit layout method applied in a voltage divider is disclosed. The circuit layout method includes: defining a plurality of resistive modules on a circuit layout, serially connecting the resistive modules between a first reference voltage level and a second reference voltage level for producing a plurality of divided voltage levels; and for each of the resistive modules, defining a plurality of nodes on the circuit layout, wherein the nodes include an input terminal and an output terminal of the resistive module; and for each node pair of a plurality of node pairs among the nodes, selecting a configuration manner for defining a circuit configuration of the node pair to make the input terminal and the output terminal of the resistive module have a correspondingly specified resistive value therebetween from three different configuration states, wherein the configuration states are an open-circuit configuration, a short-circuit configuration and a connecting configuration. The connecting configuration corresponds to the node pair and arranges a resistive component with a predetermined resistive value between nodes of the node pair.

According to yet another aspect of the present invention, a circuit layout method applied in a voltage divider is disclosed. The circuit layout method includes: defining a plurality of resistive modules on a circuit layout, serially connecting the resistive modules between a first reference voltage level and a second reference voltage level for producing a plurality of divided voltage levels; and for each of the resistive modules, defining a plurality of nodes arranged on the circuit layout in a matrix format, wherein the nodes include an input terminal and an output terminal of the resistive module; electronically connecting at least one resistive component between the input terminal and the output terminal to make the input terminal and the output terminal of the resistive module have a specified resistive value therebetween. The resistive component is connected between two nodes of one node pair among the nodes, and each of the resistive components has a correspondingly predetermined resistive value.

According to yet another aspect of the present invention, a resistive module is disclosed. The resistive module includes a plurality of nodes arranged on a circuit layout, and at least a resistive component. The nodes include an input terminal and an output terminal of the resistive module. The resistive component is electronically connected between the input terminal and the output terminal of the resistive module to thereby make the input terminal and the output terminal have a specified resistive value therebetween. In addition, the resistive component is electrically connected between two nodes of a node pair among to the nodes, and each resistive component has a corresponding predetermined resistive value.

According to yet another aspect of the present invention, a voltage divider is disclosed. The voltage divider includes a plurality of resistive modules each including a plurality of nodes and at least a resistive component. In addition, the resistive modules are disposed on a circuit carrier, and are serially connected between a first reference voltage level and a second reference voltage level for generating a plurality of divided voltage levels. For each of the resistive modules, the nodes are arranged on the circuit carrier in a matrix format, and the nodes include an input terminal and an output terminal of the resistive module; furthermore, the resistive component is electrically connected between the input terminal and the output terminal of the resistive module to thereby make the input terminal and the output terminal have a specified resistive value therebetween. The resistive component is electrically connected between two nodes of one node pair among the nodes, and each resistive component has a corresponding predetermined resistive value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional Gamma voltage divider.

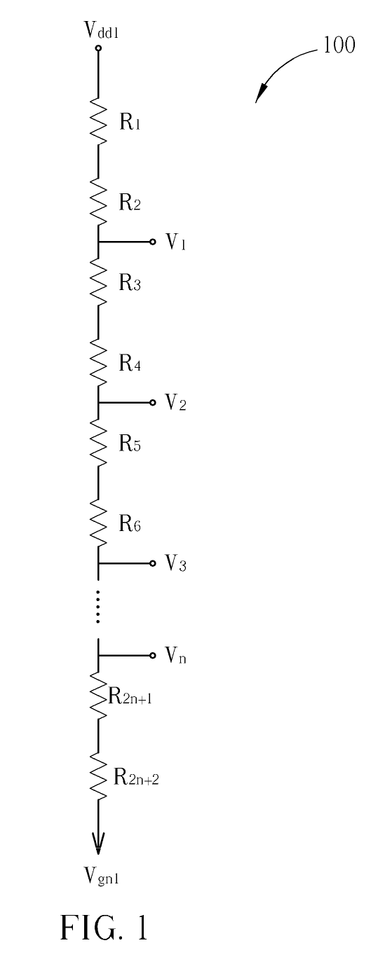

FIG. 2 is a diagram illustrating another conventional Gamma voltage divider.

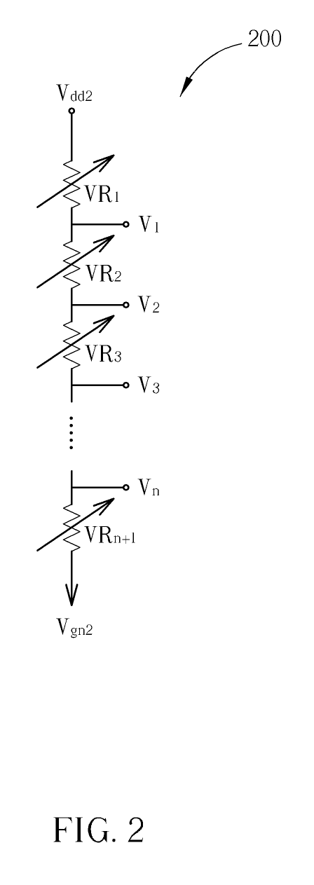

FIG. 3 is a diagram illustrating a Gamma voltage divider according to an embodiment of the present invention.

FIG. 4 is a diagram illustrating a first equivalent circuit of a resistive module shown in FIG. 3.

FIG. 5 is a diagram illustrating a second equivalent circuit of the resistive module shown in FIG. 3.

FIG. 6 is a diagram illustrating a third equivalent circuit of the resistive module shown in FIG. 3.

FIG. 7 is a diagram illustrating a fourth equivalent circuit of the resistive module shown in FIG. 3.

FIG. 8 is a diagram illustrating a fifth equivalent circuit of the resistive module shown in FIG. 3.

FIG. 9 is a diagram illustrating a sixth equivalent circuit of the resistive module shown in FIG. 3.

FIG. 10 is a flowchart illustrating a layout method of a resistive module according to an embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

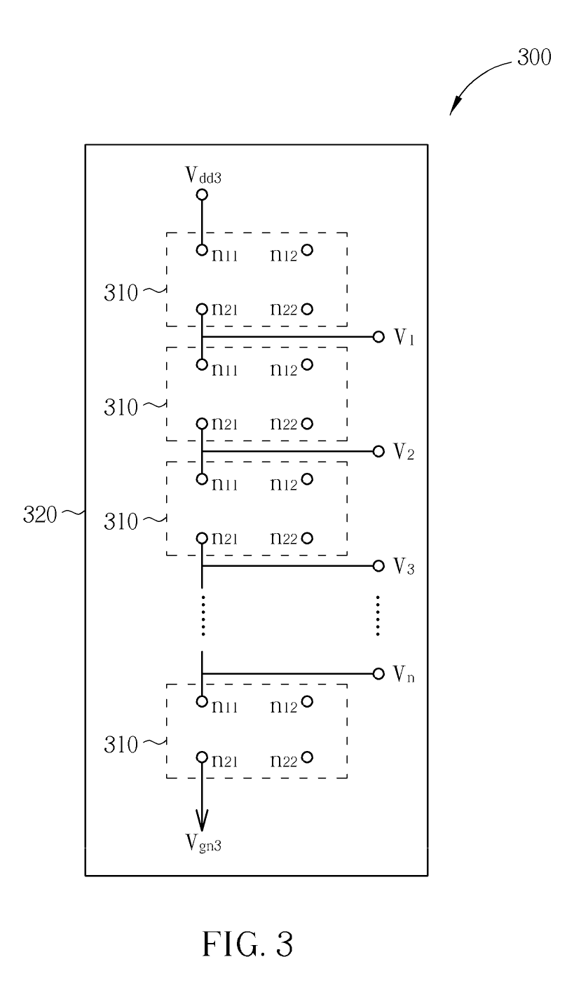

Please refer to FIG. 3; FIG. 3 is a diagram illustrating a Gamma voltage divider 300 according to an embodiment of the present invention. In this embodiment, Gamma voltage divider 300 includes a plurality of resistive modules 310 arranged on a circuit carrier 320, such as a printed circuit board (PCB) or a chip). In addition, the resistive modules 310 are serially connected between a first reference voltage level Vdd3 and a second reference voltage level Vgn3 to therefore generate a plurality of divided voltage levels V₁-Vₙ.

As shown in FIG. 3, each resistive module 310 includes a plurality of nodes n11, n12, n21, n22 arranged on the circuit carrier 320 in a matrix format. In addition, among the nodes n11, n12, n21, n22 of each resistive module 310, there are an input terminal and an output terminal corresponding to each resistive module 310. In this embodiment, the nodes n11 and n21 respectively serve as the input terminal and the output terminal for each resistive module 310.

Furthermore, each resistive module 310 includes at least one resistive component electronically connected between the input terminal (i.e., node n11) and the output terminal (i.e., n21). In other words, the resistive component is electronically connected between two nodes of a node pair among the nodes to therefore make the input terminal and the output terminal of the resistive module have a specified resistive value therebetween, and each resistive component has a corresponding predetermined resistive value. The possible arrangements of the resistive component(s) in each resistive module 310 are disclosed in the following description.

For brevity, in the following description of the invention, each resistive module 310 includes four nodes n11, n12, n21, n22, where the node n11 is the input terminal and the output terminal is node n21. In addition, the resistive component electronically connected to a certain node pair formed by two nodes n11 and n21 is named as R_{row-1}; the resistive component electronically connected to a certain node pair formed by two nodes n12 and n22 is named as R_{row-2}; the resistive component electronically connected to a certain node pair formed by two nodes n11 and n12 is named as R_{col-1}; the resistive component electronically connected to a certain node pair formed by two nodes n21 and n22 is named as R_{col-2}. However, four nodes within the resistive module 310 are for illustrative purposes only and not meant to be limitations of the present invention. That is, in other embodiments of the present invention, a certain resistive module 310 is capable of adopting more nodes defining a circuit layout thereof. Besides, the naming of the resistive components R_{row-1}, R_{row-2}, R_{col-1}, and R_{col-2} only expresses the relative positions within each resistive module 310, and is irrelevant to any specific resistive values of the resistive components R_{row-1}, R_{row-2}, R_{col-1}, and R_{col-2}. In other words, the resistive components R_{row-1}, R_{row-2}, R_{col-1}, and R_{col-2} of different resistive modules 310 are allowed to have different resistive values and can be implemented using different resistive components; for different resistive modules 310, the resistive components R_{row-1}, R_{row-2}, R_{col-1}, and R_{col-2} can be other kinds of resistive components and/or with other predetermined resistive values. Moreover, the number of the resistive components is not meant to be a limitation of the present invention. Therefore, using more nodes to define a circuit layout of the resistive module 310 and using more resistive components to define specific resistive values of the resistive module 310 are also acceptable.

In the following description, the input terminal n11 and output terminal n21 are configured to calculate a correspondingly particular resistive value of each resistive module 310. However, this is for illustrative purposes only and not meant to be a limitation of the present invention. In an alternative design, it is acceptable to set different nodes of the resistive module 310 as the input terminal and output terminal for computing a correspondingly particular resistive value of each resistive module 310. Furthermore, in the following description, all the resistive components are implemented by using resistors, but in other embodiments any resistive component with a predetermined resistive value (e.g., a capacitive component) can be employed. These alternative designs all fall in the scope of the present invention.

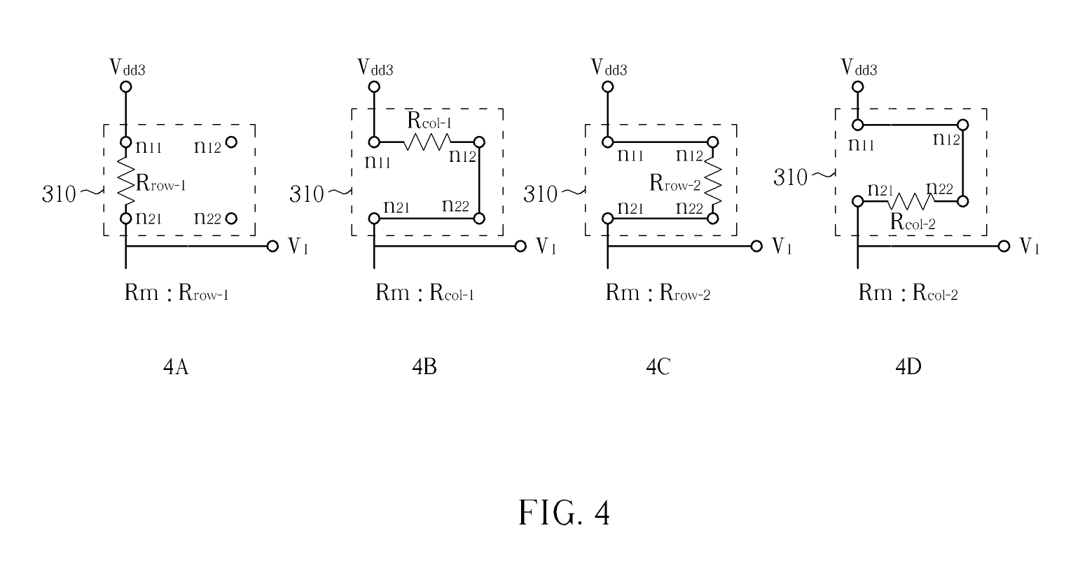

Please refer to FIG. 3-FIG. 9 simultaneously. FIG. 4 to FIG. 9 are diagrams illustrating a plurality of equivalent circuits of the resistive module 310 shown in FIG. 3. As previously mentioned, four nodes n11, n12, n21, n22 are arranged on the circuit carrier 320 in a matrix format. As shown in sub-diagrams 4A, 4B, 4C, and 4D of FIG. 4, four equivalent circuits have four different connecting configurations of arranging one resistive component only upon one node pair of the resistive module 310 to make the specified resistive value Rm of the equivalent circuit in sub-diagram 4A be R_{row-1}; the specified resistive value Rm of the equivalent circuit in sub-diagram 4B is R_{col-1}; the specified resistive value Rm of the equivalent circuit in sub-diagram 4C is R_{row-2}, and the specified resistive value Rm of the equivalent circuit in sub-diagram 4D is R_{col-2}, where Rm represents the equivalent resistive value of a resistive module 310.

As shown in sub-diagram 4A in FIG. 4, only a resistive component R_{row-1} is connected between nodes n11 and node n21, and the remaining three node pairs (i.e., nodes n11 and n12, nodes n12 and n22, and nodes n21 and n22) are all in an open-circuit configuration respectively. The circuit arrangement shown in the sub-diagram 4A of FIG. 4 hence makes an equivalent resistive value Rm between the input terminal (i.e., node n11) and output terminal (i.e., node n21) of the resistive module 310 have the predetermined resistive value of the resistive component R_{row-1}. In short, the equivalent resistive value Rm of the resistive module 310 with the arrangement as shown in sub-diagram 4A of FIG. 4 can be expressed as Rm=R_{row-1}.

Similarly, for the circuit layout shown in sub-diagram 4B of FIG. 4, only a resistive component R_{col-1} is connected between the node n11 and node n21, and the remaining three node pairs are in an open-circuit configuration (between nodes n11 and n21) and short-circuit configurations (between nodes n12 and n22, and between nodes n21 and n22) respectively; that is to say, the equivalent resistive value Rm of the resistive module 310 with the arrangement as shown in sub-diagram 4B of FIG. 4 can be expressed as Rm=R_{col-1}. In addition, for the circuit layout shown in sub-diagram 4C of FIG. 4, the equivalent resistive value Rm of the resistive module 310 can be expressed as Rm=R_{row-2}, and for the circuit layout shown in sub-diagram 4D of FIG. 4, the equivalent resistive value Rm of the resistive module 310 can be expressed as Rm=R_{col-2}.

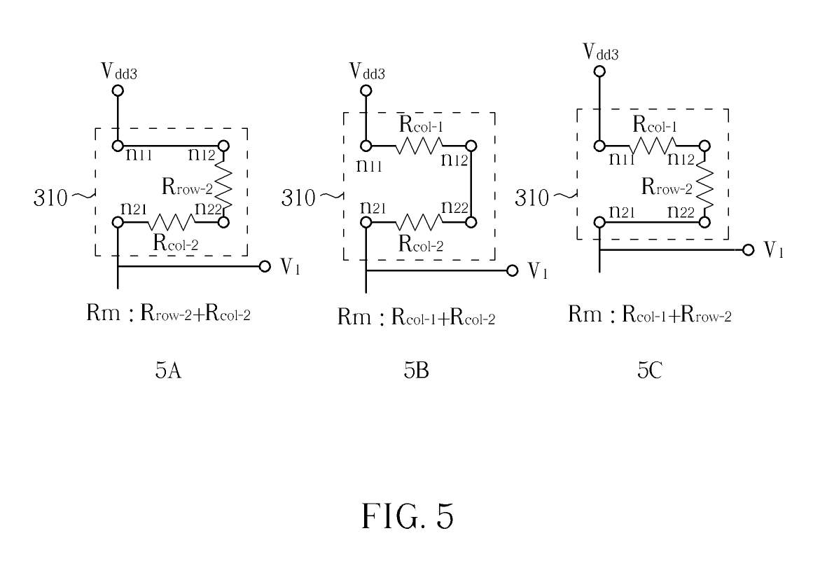

Please refer to FIG. 5; three equivalent circuits shown in sub-diagrams 5A, 5B, and 5C illustrate three different connecting configurations of respectively arranging one resistive component upon each of two individual node pairs of the resistive module 310 to therefore make the specified resistive value Rm of three equivalent circuits shown in sub-diagrams 5A, 5B, and 5C equal to a summation of two resistive components. In other words, among the connecting configurations of three equivalent circuits shown in sub-diagrams 5A, 5B, and 5C of FIG. 5, the specified resistive value (Rm) of resistive module 310 is set by serially connected resistive components (as shown in FIG. 5), and the reminding node pairs are with open-circuit configurations and/or short-circuit configurations respectively.

As a result, as shown in FIG. 5, the equivalent resistive value Rm of the resistive module 310 with the arrangement (connecting configuration) shown in sub-diagram 5A of FIG. 5 is Rm=R_{row-2}+R_{col-2}. Furthermore, the equivalent resistive value Rm of the resistive module 310 with the arrangement (connecting configuration) shown in sub-diagram 5B of FIG. 5 is Rm=R_{col-1}+R_{col-2}. The equivalent resistive value Rm of the resistive module 310 with the arrangement (connecting configuration) shown in sub-diagram 5C of FIG. 5 is Rm=R_{col-1}+R_{row-2}.

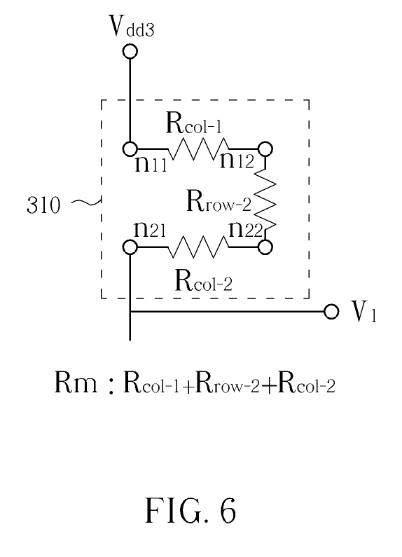

Please refer to FIG. 6; FIG. 6 illustrates an equivalent circuit with a connecting configuration of arranging one resistive component upon each of three individual node pairs (i.e., nodes n11 and n12, nodes n12 and n22, and nodes n21 and n22) among the nodes of the resistive module 310 and setting the remaining node pair (i.e., nodes n11 and n21) as an open-circuit configuration to therefore make the specified resistive value Rm of the equivalent circuit shown in FIG. 6 equal to a summation of three resistive components. In other words, regarding the connecting configuration of the equivalent circuit shown in FIG. 6, the specified resistive value (Rm) of the resistive module 310 is equal to an equivalent resistive value of serially connected three resistive components; that is, Rm=R_{col-1}+R_{row-2}+R_{col-2}.

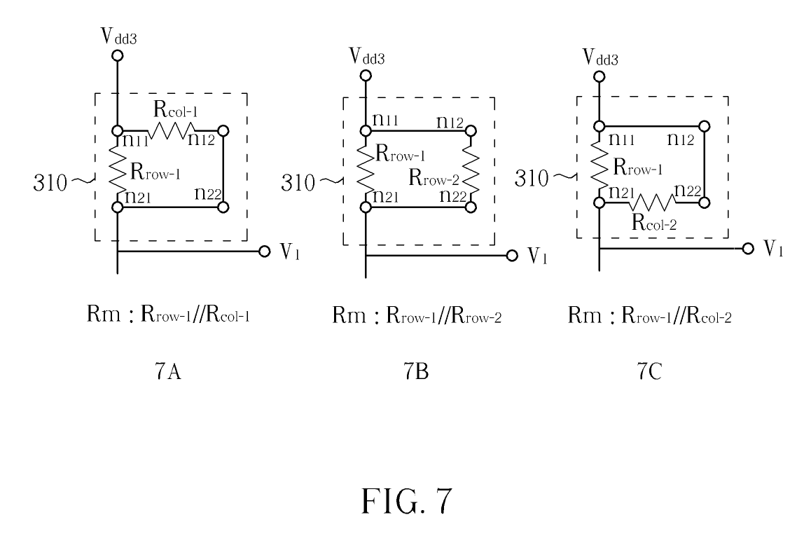

Please refer to FIG. 7; three equivalent circuits shown in sub-diagrams 7A, 7B, and 7C illustrate three different connecting configurations of respectively arranging one resistive component upon each of two individual node pairs of the resistive module 310 and setting the remaining two node pairs among the nodes as short-circuit configurations to therefore make the specified resistive value Rm of three equivalent circuits shown in sub-diagrams 7A, 7B, and 7C equal to an equivalent resistive value of two resistive components connected in parallel. In other words, in this embodiment, two node pairs among four node pairs in the resistive module 310 have a connecting configuration with respective resistive components applied thereto, and the remaining two node pairs are respectively configured in a short-circuit configuration with an equivalent resistive value equal to zero. As a result, the two particular node pairs each have a resistive component connected therein, and the equivalent resistive value Rm of the equivalent circuits shown in sub-diagrams 7A, 7B, and 7C of FIG. 7 is equal to an equivalent resistive value of two resistive components parallel connected between the input terminal (i.e., node n11) and the output terminal (i.e., node n21).

Taking the equivalent circuit shown in sub-diagram 7A of FIG. 7 for instance, by arranging a resistive component Rcol-1 between the nodes n11 and n12, and another resistive component Rrow-1 between the nodes n11 and n21; and then setting the connecting configuration between node pairs n12-n22 and n21-n22 as a short-circuit configuration with an equivalent resistive value equal to zero therebetween respectively, the equivalent resistive value Rm of the equivalent circuit shown in sub-diagram 7A of FIG. 7 is Rm=R_{row-1}∥R_{col-1}.

Simultaneously, for the equivalent circuit shown in sub-diagram 7B of FIG. 7, the equivalent resistive value Rm of the resistive module 310 is Rm=Rrow-1∥Rrow-2. Furthermore, the equivalent resistive value Rm of the resistive module 310 with the arrangement (connecting configuration) shown in the sub-diagram 7C of FIG. 7 is Rm=R_{row-1}∥R_{col-2}.

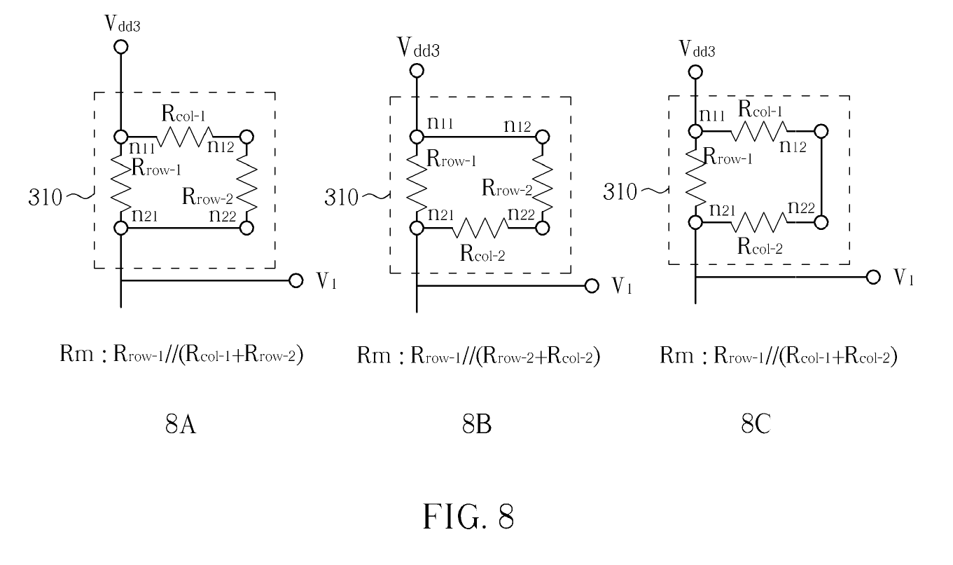

Please refer to FIG. 8; three equivalent circuits shown in sub-diagrams 8A, 8B, and 8C illustrate three different connecting configurations of respectively arranging one resistive component upon each of three individual node pairs among the nodes n11, n12, n21 and n22 of the resistive module 310 and setting a remaining node pair among the nodes as a short-circuit configuration to make the specified resistive value Rm of three equivalent circuits shown in sub-diagrams 8A, 8B, and 8C equal to an equivalent resistive value of two serially-connected resistive components connected with the remaining resistive component in parallel. That is, in this embodiment, in a resistive module 310 with four node pairs (i.e., nodes n11-n12, nodes n12-n22, nodes n21-n22 and nodes n11-n21), there are three node pairs each with a connecting configuration having a resistive component applied therein and one remaining node pair with a short-circuit configuration having an equivalent resistive value equal to zero. As a result, in this embodiment, the circuit layout of the resistive module 310 adopts both a parallel connection layout and a serial connection layout at the same time.

Taking the equivalent circuit shown in sub-diagram 8A of FIG. 8 for instance, by arranging a resistive component Rcol-1 between the nodes n11 and n12, one resistive component Rrow-1 between the nodes n11 and n21, one resistive component Rrow-2 between the nodes n12 and n22, and a short-circuit configuration with an zero equivalent resistive value between the node pair n21-n22,

the equivalent resistive value Rm of the equivalent circuit shown in sub-diagram 8A of FIG. 8 is Rm=R_{row-1}∥R_{col-1}+R_{row-2}.

Simultaneously, for the equivalent circuit shown in sub-diagram 8B of FIG. 8, the equivalent resistive value Rm of the resistive module 310 is Rm=R_{row-1}∥R_{col-2}+R_{row-2}. Furthermore, the equivalent resistive value Rm of the resistive module 310 with the arrangement (connecting configuration) shown in sub-diagram 8C of FIG. 8 is Rm=R_{row-1}∥R_{col-1}+R_{col-2}.

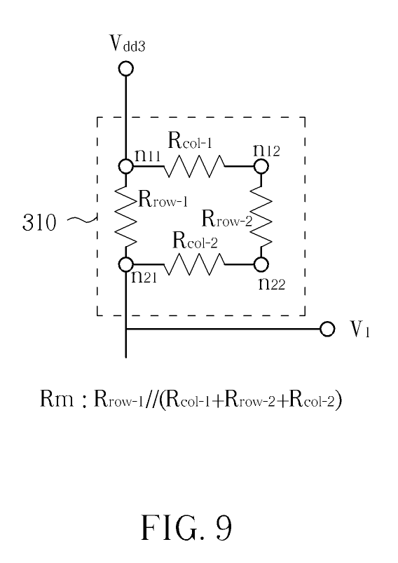

Please refer to FIG. 9; FIG. 9 illustrates an equivalent circuit with a connecting configuration of respectively arranging one resistive component upon all the node pairs (i.e., nodes n11 and n12, nodes n12 and n22, nodes n21 and n22, and nodes n11 and n21) among the nodes of the resistive module 310 to make the specified resistive value Rm of the equivalent circuit shown in FIG. 9 equal to an equivalent resistive value of a resistive component parallel connected with remaining three resistive components connected in series. That is, in this embodiment, the circuit layout of the resistive module 310 adopts both a parallel connection layout and a serial connection layout at the same time. As a result, by adopting the connecting configuration of the equivalent circuit shown in FIG. 9, the specified resistive value Rm of the resistive module 310 is expressed as Rm=R_{row-1}∥R_{col-1}+R_{col-2}+R_{row-2}.

In view of the aforementioned descriptions directed to the circuit layouts illustrated in FIG. 4-FIG. 9, it is readily known that each resistive module 310 has fifteen probable arrangements available for selection. Therefore, by selecting an appropriate circuit layout of the resistive module 310, designers have extreme flexibility to get the most approximate resistive value to meet the design requirement.

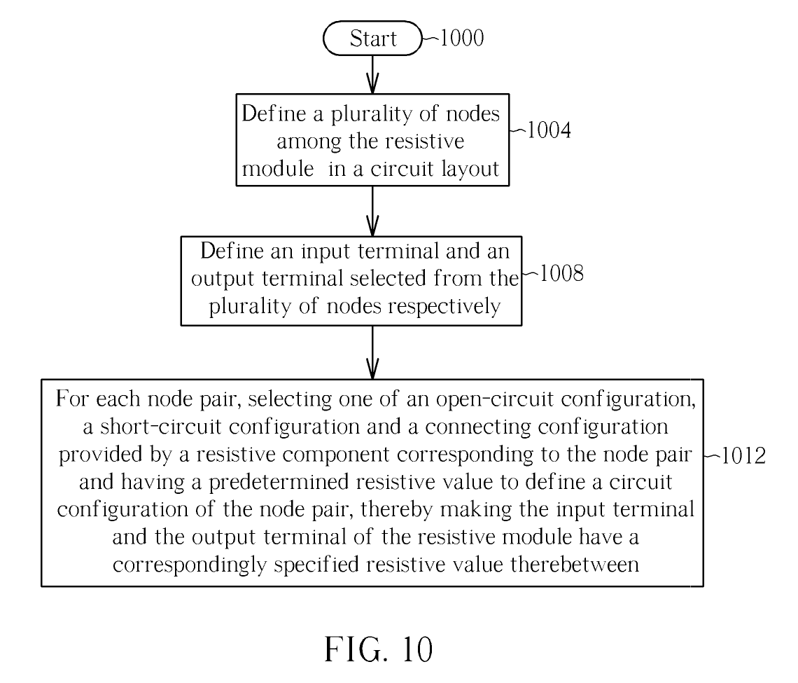

Please refer to FIG. 10 in conjunction with FIG. 4-FIG. 9. FIG. 10 is a flowchart illustrating a layout method of a resistive module according to an embodiment of the present invention. Please note that if the result is substantially the same, the steps are not limited to be executed according to the exact order shown in FIG. 10. The flow includes the following steps:

Step 1000: Start.

Step 1004: Define a plurality of nodes (i.e., n11, n12, n21 and n22 in this embodiment) among the resistive module 310 in a circuit layout 320.

Step 1008: Define an input terminal and an output terminal selected from the plurality of nodes (i.e., n11, n12, n21 and n22 in this embodiment) respectively. For instance, the node n11 is defined to act as the input terminal and the node n21 is defined to act as the output terminal.

Step 1012: For each node pair of a plurality of node pairs (i.e., four node pairs in this embodiments) among the nodes (i.e., n11, n12, n21 and n22), selecting one of an open-circuit configuration, a short-circuit configuration and a connecting configuration provided by a resistive component corresponding to the node pair and having a predetermined resistive value to define a circuit configuration of the node pair, thereby making the input terminal and the output terminal of the resistive module 310 have a correspondingly specified resistive value (equivalent resistive value Rm) therebetween.

Since all the equivalent circuits of each resistive module 310 have been detailed above, further description of the steps in FIG. 10 is omitted here for brevity.

By adopting the flow disclosed in FIG. 10, designers can set a configuration of resistive components according to the requirements of different resistive values. In other words, by assigning a connecting configuration (i.e., a resistive component, a short-circuit configuration, or an open-circuit configuration) to each node pair to form a circuit configuration selected from the fifteen possible arrangements as shown in FIG. 4-FIG. 9, the designers not only can get the most approximate resistive value approaching the required specified resistive value but also can save the layout area accordingly since the nodes of each resistive module 310 are arranged in a matrix format.

In addition, the Gamma voltage divider 300 illustrated in FIG. 3 is disposed in an LCD display apparatus, and the plurality of divided voltage levels V₁-Vₙ are Gamma reference voltages required by the LCD display apparatus. By applying the flow illustrated in FIG. 10, the designer can determine the resistive component arrangement of each resistive module 310 in the Gamma voltage divider 300 according to the design requirements when designing the Gamma voltage divider 300. As each specified resistive value between the input terminal and the output terminal of each resistive module 310 can approach the required ideal resistive value, the Gamma voltage divider 300 of the present invention has advantages such as simpler structure, lower cost and smaller area, and additionally provides precise Gamma reference voltages to solve the conventional problems.

Please note that the resistive module and layout method disclosed previously are applied to the Gamma voltage divider of the LCD display apparatus. However, this is for illustrative purposes only and not meant to be limitations of the present invention. For example, the resistive modules of the present invention can be employed in any voltage dividers or other applications to replace conventional resistive components. In other words, any apparatus and method using one of the aforementioned resistive module, voltage divider and related layout method all fall within the scope of the present invention.

In conclusion, the layout method using the aforementioned resistive modules of the present invention defines a plurality of nodes arranged in a matrix format on a circuit layout, and then defines at least one resistive component electronically connected between two nodes among the defined nodes to make the input terminal and the output terminal of the resistive module have a correspondingly specified resistive value therebetween. In addition, by adopting the layout method of the present invention, the designers can design a plurality of voltage dividing components (e.g., resistive modules) required by a voltage divider (e.g., a Gamma voltage divider) according to the design requirements to make the resistive values respectively approach the required resistive values.

Furthermore, due to the matrix-format layout structure, the layout area of the voltage divider hence is greatly reduced. In addition, each voltage dividing component, such as a resistive module, can use low-cost resistors to implement the resistive components. In this way, the production cost of the voltage divider (e.g., the Gamma voltage divider) is not greatly increased.

Those skilled in the art will readily observe that numerous modifications and alterations of the device and method may be made while retaining the teachings of the invention.

What is claimed is:

1. A resistive module, comprising:
a plurality of nodes, including an input terminal and an output terminal of the resistive module;
at least a resistive component, electronically connected between the input terminal and the output terminal of the resistive module to thereby make the input terminal and the output terminal have a specified resistive value therebetween, wherein the resistive component is electrically connected between two nodes of a node pair among the nodes, and each resistive component has a corresponding predetermined resistive value.

2. The resistive module of claim 1, wherein each resistive component is a resistor.

3. The resistive module of claim 1, comprising a plurality of resistive components electrically connected between the input terminal and the output terminal of the resistive module and further electrically connected to at least three specified node pairs of the nodes respectively, wherein each of the resistive components is electronically connected between two nodes of a corresponding specified node pair among the three specified node pairs.

4. The resistive module of claim 1, comprising a plurality of resistive components connected in parallel between the input terminal and the output terminal of the resistive module and further electrically connected to at least two specified node pairs of the nodes respectively, wherein each of the resistive components is electronically connected between two nodes of a corresponding specified node pair of the two specified node pairs.

5. The resistive module of claim 1, wherein the nodes are arranged on a circuit carrier in a matrix format.

6. The resistive module of claim 5, wherein the circuit carrier is a circuit board.

7. A voltage divider, comprising:
a plurality of resistive modules, disposed on a circuit carrier, the resistive modules being serially connected between a first reference voltage level and a second reference voltage level for generating a plurality divided voltage levels, each of the resistive modules comprising:
a plurality of nodes, arranged on the circuit carrier in a matrix format, wherein the nodes include an input terminal and an output terminal of the resistive module; and
at least one resistive component, electrically connected between the input terminal and the output terminal of the resistive module to thereby make the input terminal and the output terminal have a specified resistive value therebetween, wherein the resistive component is electrically connected between two nodes of one node pair among the nodes, and each resistive component has a corresponding predetermined resistive value.

8. The voltage divider of claim 7, being disposed on a liquid crystal display apparatus, wherein the divided voltage levels are a plurality of Gamma reference voltages for the liquid crystal display apparatus.
